(19) United States
(12) Patent Application Publication
(10) Pub. No.: US 2008/0149556 A1
(43) Pub. Date: Jun. 26, 2008

(54) Horizontal sanitary lenticular cartridge housing assembly

(76) Inventors: George T. Quigley, Cottekill, NY (US); William P. Kearney, Kingston, NY (US); Harry Personeus, Fishkill, NY (US)

Correspondence Address: JACOBSON HOLMAN PLLC, 400 SEVENTH STREET N.W., SUITE 600, WASHINGTON, DC, 20004, US

(21) Appl. No.: 11/643,680

(22) Filed: Dec. 22, 2006

(51) Int. Cl. B01D 27/14

(52) U.S. Cl. 210/323.2

(57) ABSTRACT

A horizontally oriented stainless steel tank cylinder having a front tank flange and a rear tank flange. The rear tank flange has a sanitary process inlet and a sanitary outlet. The tank cylinder is inclined upwardly from the rear tank flange to the front tank flange. A media tray is slidably mounted in the tank cylinder for ease of removal of a plurality of filter rings forming lenticular filter cartridges. The tray has a double o-ring design for connecting to a static center core of a plurality of lenticular filter cartridges and the sanitary process outlet.

### FIELD OF THE INVENTION

The present invention relates to the field of sanitary lenticular cartridge housings used for filtration of liquids.

### BACKGROUND OF THE INVENTION

Previous designs for lenticular cartridge housings accommodated a vertically extending, double open end cartridge that was held in place over a central locating perforated tube and threaded center post. The threaded central post was fixed on one end in the housing and was designed to allow for the tightening of the cartridges end to end by the securing of the vertical top of the housing with an external tightening nut or was supplied with an internal tightening nut. When the tightening nut was secured, pressure was applied to the end gaskets of each cartridge to prevent bypass of liquid between the cartridge and the housing and/or in addition to securing the gaskets between individual cartridges to prevent bypass.

### SUMMARY OF THE INVENTION

By the present invention, a lenticular style filter cartridge is provided in a housing in a vertical and/or horizontal orientation. Operating in the vertical configuration will allow the operator to capture as much filtered liquid as possible from the filter housing. Operating in the horizontal configuration provides several advantages. The housing is operated with liquid flow from outside the housing into the housing or from inside the housing to outside the housing.

When the lenticular filter cartridge housing is in the horizontal mode it is placed at a 5°-10° slope toward the process piping end to allow for recovery of unfiltered heel that may be left in the housing. This also prevents liquid from spilling from the access head end of the housing when the head is opened for removal of spent cartridges.

There is a media tray provided in the housing that allows for the cartridges to be individually placed or removed from the housing. The end of the tray adjacent to the access head end of the housing includes a hand grip opening to grip and facilitate removal of the tray from the housing. The tray makes it easier for the operator to handle a plurality of the cartridges.

The lenticular filter cartridges are equipped with a static center core. The core includes a double o-ring female end and male receptor end with a quarter turn lock design. This double o-ring design is cleaner and more sanitary than previous designs. It eliminates the tightening nut, center tube and center post of vertically oriented assemblies. The gaskets necessary for the parts of a vertical housing are eliminated. Proper and consistent installation of the cartridges in the housing is ensured. The double o-ring design prevents bypass between the cartridge and the housing and/or other cartridges due to operator error when installing the cartridges.

The present invention allows for the housing to be placed in the vertical or horizontal mode and provides several advantages over previous designs as follows:
1. This invention provides a housing that eliminates threads in the process area. Threading is a source for retention of contaminated product.
2. This invention eliminates operator error and the need to tighten the cartridges when installing. The cartridge tray is loaded outside of the housing.
3. This invention provides for a fully cleanable and sanitary housing.
4. This invention is more ergonomic, allowing the installation and removal of the cartridges at a comfortable height.
5. This invention is provided with a unique tray design which incorporates a double o-ring quarter turn lock to insure no bypass of liquid to be filtered, between the cartridges and the housing and between the cartridges.
6. This invention has a double access head design which allows for full access to all parts of the housing.
7. This invention allows for hinged access heads to prevent worker injury.
8. This invention allows for flanged access heads so that the unit may be provided constructed to manufacturer's standards or with an ASME code designation or similar standard pressure code design.
9. This invention allows for full access for polishing and electropolishing of all surfaces.
10. This invention allows for dual flow direction of the fluid through the lenticular cartridge.
11. This invention allows for the elimination of an overhead device to lift the cartridges from a vertical housing.
12. This invention allows for the use of a selection of materials that can be used to manufacture the housings.
13. This invention also allows a choice of operation in either a vertical or a horizontal mode.

Accordingly, it is an object of the present invention to provide a horizontally oriented stainless steel tank cylinder having a front tank flange and a rear tank flange, with the rear tank flange having a sanitary process inlet and a sanitary outlet, with the tank cylinder inclined upwardly from the rear tank flange to the front tank flange.

It is another object of the present invention to provide a horizontally oriented stainless steel tank cylinder having a front tank flange and a rear tank flange, with the rear tank flange having a sanitary process inlet and a sanitary outlet, with the tank cylinder inclined upwardly from the rear tank flange to the front tank flange, with a media tray being slidably mounted in the tank cylinder for ease of removal of a plurality of filter rings forming a lenticular filter cartridge.

It is still yet another object of the present invention to provide a horizontally oriented stainless steel tank cylinder having a front tank flange and a rear tank flange, with the rear tank flange having a sanitary process inlet and a sanitary outlet, with the tank cylinder inclined upwardly from the rear tank flange to the front tank flange, with a media tray being slidably mounted in the tank cylinder for ease of removal of a plurality of filter rings forming lenticular filter cartridges, and with the tray having a double o-ring design for connecting to a static center core of a plurality of lenticular filter cartridges and the sanitary process outlet.

These and other objects of the invention, as well as many of the intended advantages thereof, will become more readily apparent when reference is made to the following description taken in conjunction with the accompanying drawings.

### BRIEF DESCRIPTION OF THE DRAWINGS

The following drawings illustrate examples of various components of the horizontal sanitary lenticular cartridge housing assembly disclosed herein, and are for illustrative purposes only. Other embodiments that are substantially similar can use other components that have a different appearance.

FIG. 1 is side view of a horizontal sanitary lenticular cartridge housing of the present invention with a partial cutaway view of the tank cylinder for viewing of a plurality of filter cartridges mounted on a static center core.

FIG. 2 is a plan view of the housing.

FIG. 3 is an end view of the rear flange of the housing.

FIG. 4 is a perspective view of the housing inclined at an angle of 5°-10°.

FIG. 5 is a sectional view taken along line 5-5 of FIG. 3.

FIG. 6 is an enlarged sectional view of the area encircled in FIG. 5 and labeled as FIG. 6.

FIG. 7 illustrates a media tray supporting a plurality of filter cartridges with the tank cylinder removed.

FIG. 8 is a perspective view of the media tray for holding the interconnected filter cartridges.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

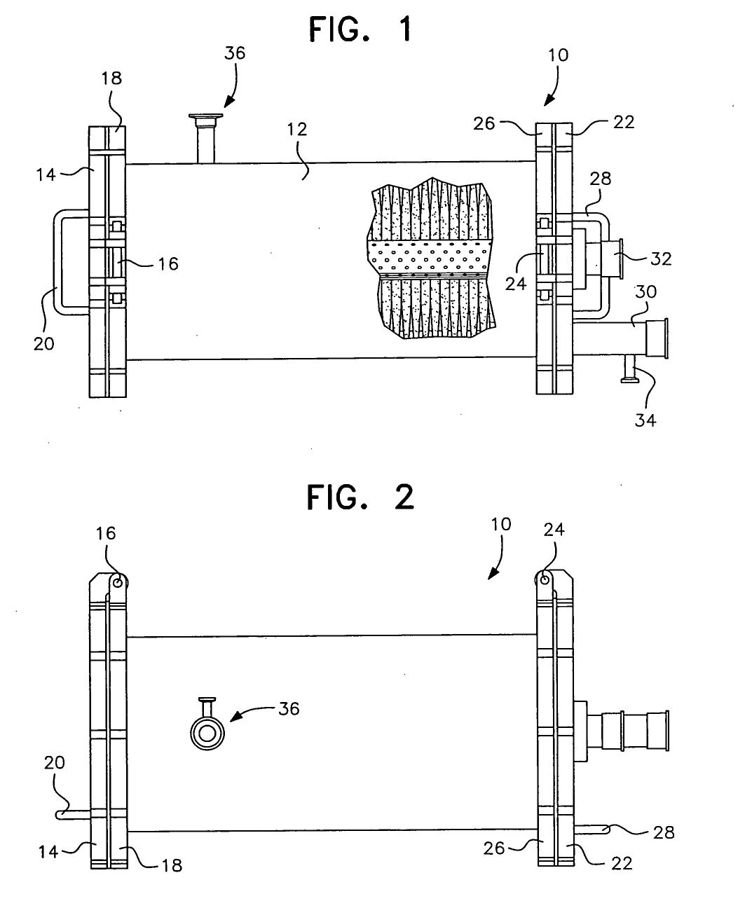

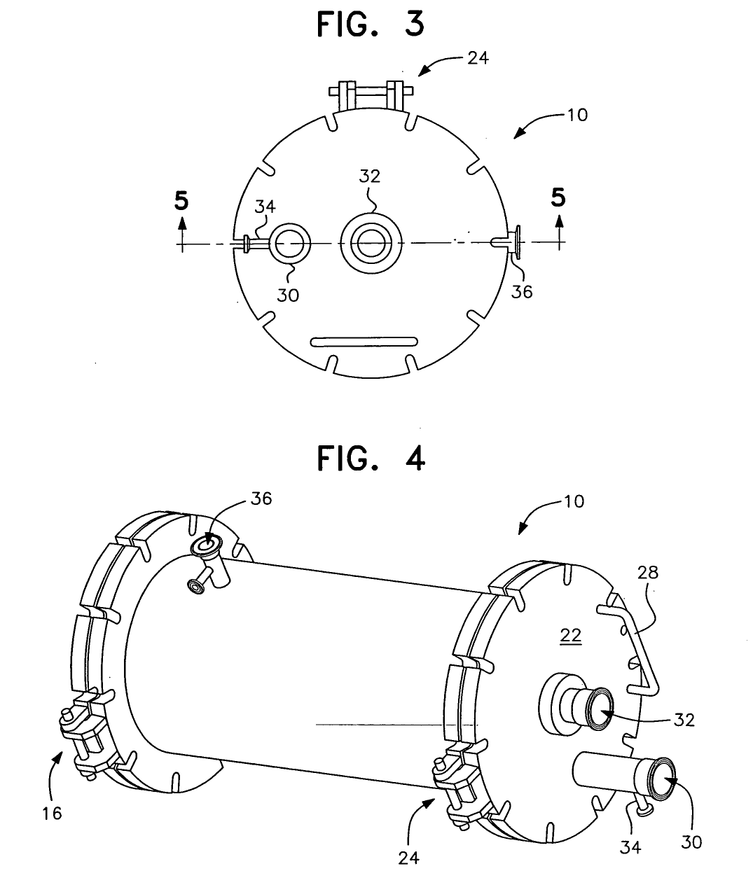

With reference to the drawings, in general, and to FIGS. 1-4, in particular, a double o-ring horizontal sanitary lenticular cartridge housing assembly embodying the teachings of the subject invention is generally designated as 10. Withe reference to its orientation in FIG. 1, the assembly includes a 316 stainless steel tank cylinder 12 having a front tank flange 14 pivotally mounted by hinge 16 to front plate 18. A handle 20 is used to open and close the front tank flange. A silicone o-ring flange is interposed between the front tank flange 14 and front tank plate 18. This seals the front end of the tank cylinder.

At a rear end of the cylinder 12 is located a rear tank flange 22 pivotally mounted by hinge 24 on rear tank plate 24. A handle 26 is used to open and close the rear tank flange 22. A silicone o-ring flange is also interposed between the rear tank flange 22 and rear tank plate 26 for sealing the rear end of the tank cylinder 12.

As best shown in FIG. 4, the rear tank flange 22 includes a sanitary process inlet 30 and a sanitary process outlet 32. The inlet and outlet may be reversed so that liquid flows in a “backward” direction so as to reduce or eliminate any unfiltered liquid volume.

Extending from the sanitary process inlet 30 is a sanitary drain 34. Located on top of the tank cylinder 12, as shown in FIGS. 1, 2 and 4, is a sanitary gauge/vent 36.

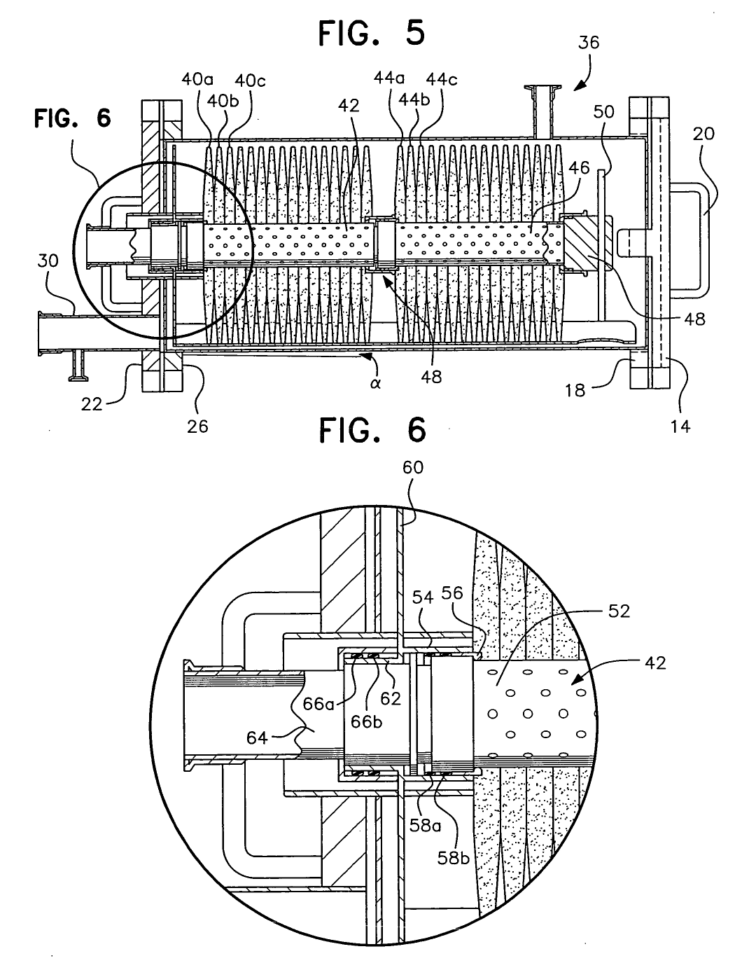

As shown in FIG. 5, a plurality of filter cartridges 40a, 40b, 40c, . . . are mounted on a central, horizontally extending central core pipe 42 for transmission of liquid filtered through the filter media and allowed to pass from the interior of the filter media into the core 42. In the example shown, there are two sets of filter media with filter cartridges 44a, 44b, 44c, . . . similarly mounted on a core 46. The two cores are interconnected at 48 with a non-perforated portion such that non-filtered liquid cannot enter into the central core. Only liquid that has passed through the filter material is allowed to enter the central cores.

A plug 48 seals the open end of the core located adjacent to the front tank flange 14. A turn rod 50 may be used to ensure a positive seal between the lenticular cartridge and the filter housing to ensure that only filtered liquid passes into the central core.

As shown in an enlarged view of FIG. 6, the end 52 of core 42 adjacent to the rear tank flange fits into coupling section 54 and is held in place by circumferential arms 56. Two o-rings 58a, 58b seal the connection between the coupling and the end 52 of core 42. The coupling section 54 extends from vertically extending plate 60.

On the opposite side of the plate from coupling section 54 is coupling section 62. Section 62 engages with the process outlet pipe 64 and double o-rings 66a, 66b. The outlet pipe 64 projects from the rear tank flange as is generally shown by sanitary process outlet 32.

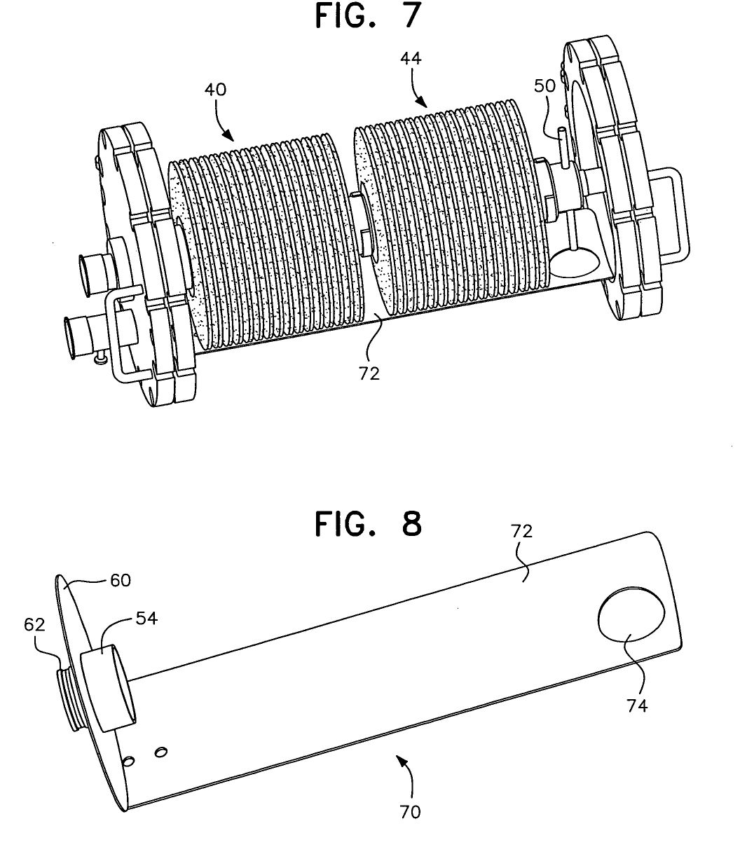

To assist in the insertion and removal of plurality of filter cartridges 40 and 44, as shown in FIG. 7, is a tray 70 including vertically extending plate 60 connected to curved bottom plate 72. Plate 72 is curved to the configuration of the filter cartridges 40, 44. The cartridges are placed on the tray 70 outside of the housing 12 and secured together. Upon opening of front tank flange 14 about hinge 16, the plate 72 of the tray 70 is exposed. An operator may reach in and grip through opening 74 and remove the tray simultaneously with the plurality of filter cartridges 40, 44 supported by the tray 70. If any alignment of the cartridges is necessary, this can be done prior to insertion of the tray and cartridges into the cylinder. The assembled cartridges 40, 44 can be easily removed from the tank cylinder in an intact condition.

As shown in FIG. 5, the tank cylinder is inclined at an angle of 5°-10° as indicated by angle ∝. After processing liquid through the tank, any residual liquid which remains unfiltered will, by gravity, flow to the sanitary process inlet 30 due to alignment with an interior surface of the tank cylinder for storage and subsequent reentry of the unfiltered liquid into the tank cylinder during the next filtration process. The present system may also be operated in the opposite direction so that flow will be from the inside of the lenticular cartridge and filtered liquid will be accumulated and directed into the area of the housing surrounding the lenticular cartridges. In this way cake or sludge from the unfiltered liquid stream would be contained within the cells of each lenticular cartridge.

The foregoing description should be considered as illustrative only of the principles of the invention. Since numerous modifications and changes will readily occur to those skilled in the art, it is not desired to limit the invention to the exact construction and operation shown and described, and, accordingly, all suitable modifications and equivalents may be resorted to, falling within the scope of the invention.

I claim:

1. A sanitary lenticular cartridge housing comprising a tank cylinder having two ends, a front tank flange pivotally mounted on said tank cylinder at one of said two ends, a rear tank flange pivotally mounted on said tank cylinder at the other of said two ends, a process inlet to said tank cylinder for feeding liquid into said tank cylinder, a process outlet from said tank cylinder for removing filtered liquid from said tank cylinder, and a filter media tray removably mounted in said tank cylinder and connected to said process outlet for supporting filter media and for movement together with the filter media into and out of the tank cylinder.

2. The sanitary lenticular cartridge housing as claimed in claim 1, wherein the tank cylinder is inclined at an angle between said two ends.

3. The sanitary lenticular cartridge housing as claimed in claim 2, wherein said angle is in the range of 5°-10°.

4. The sanitary lenticular cartridge housing as claimed in claim 1, wherein said tray includes a curved bottom plate and a vertically extending end plate.

5. The sanitary lenticular cartridge housing as claimed in claim 4, wherein the bottom plate and end plate form an L-shape.

6. The sanitary lenticular cartridge housing as claimed in claim 4, wherein said end plate includes a coupling section for engaging a central core of the plurality of filtration disks.

7. The sanitary lenticular cartridge housing as claimed in claim 1, wherein the tank cylinder is stainless steel.

8. The sanitary lenticular cartridge housing as claimed in claim 1, wherein the process inlet is aligned with an interior surface of the tank cylinder for transfer of residual liquid from the tank cylinder to the process inlet.

9. The sanitary lenticular cartridge housing as claimed in claim 6, wherein the coupling section extends from opposite sides of the end plate.

10. The sanitary lenticular cartridge housing as claimed in claim 9, wherein said coupling section includes a double o-ring.

11. A sanitary lenticular cartridge housing comprising
a tank cylinder extending horizontally and having two ends,
a front tank flange pivotally mounted on said tank cylinder at one of said two ends,
a rear tank flange pivotally mounted on said tank cylinder at the other of said two ends,
a process inlet to said tank cylinder for feeding liquid into said tank cylinder,
a process outlet from said tank cylinder for removing filtered liquid from said tank cylinder,
a filter media tray removably mounted in said tank cylinder and connected to said process outlet for supporting filter media and for movement together with the filter media into and out of the tank cylinder, and
a plurality of filtration disks mounted on the tray for movement with the tray.

12. The sanitary lenticular cartridge housing as claimed in claim 11, wherein the tank cylinder is inclined at an angle between said two ends.

13. The sanitary lenticular cartridge housing as claimed in claim 12, wherein said angle is in the range of 5°-10°.

14. The sanitary lenticular cartridge housing as claimed in claim 11, wherein said tray includes a curved bottom plate and a vertically extending end plate.

15. The sanitary lenticular cartridge housing as claimed in claim 14, wherein the bottom plate and end plate form an L-shape.

16. The sanitary lenticular cartridge housing as claimed in claim 14, wherein said end plate includes a coupling section for engaging a central core of the plurality of filtration disks.

17. The sanitary lenticular cartridge housing as claimed in claim 11, wherein the tank cylinder is stainless steel.

18. The sanitary lenticular cartridge housing as claimed in claim 11, wherein the process inlet is aligned with an interior surface of the tank cylinder for transfer of residual liquid from the tank cylinder to the process inlet.

19. The sanitary lenticular cartridge housing as claimed in claim 16, wherein the coupling section extends from opposite sides of the end plate.

20. The sanitary lenticular cartridge housing as claimed in claim 19, wherein said coupling section includes a double o-ring.
